(19) United States
(12) Patent Application Publication
(10) Pub. No.: US 2010/0061795 A1
(43) Pub. Date: Mar. 11, 2010

(54) ARRANGEMENT FOR SECURING A GEARSHIFT LEVER TRIM BASE TO THE PERIPHERY OF A SURROUNDING COVERING

(75) Inventors: Raphael Czepczak, Palaiseau (FR); Nakry Chheang, Saint Remy Les Chevreuse (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., Boulogne-Billancourt (FR)

(21) Appl. No.: 12/529,606

(22) PCT Filed: Feb. 28, 2008
(86) PCT No.: PCT/FR2008/050335

§ 371 Date: Nov. 3, 2009

(30) Foreign Application Priority Data
Mar. 5, 2007 (FR) 0753647

(51) Int. Cl. F16J 15/52; B23P 11/00

(52) U.S. Cl. 403/51; 29/505

(57) ABSTRACT

An arrangement for securing a gearshift lever trim base to the periphery of a surrounding covering, in which a guiding mechanism is provided on the lower face of the covering, which guiding mechanism can position the base of the trim upon engagement in corresponding holes provided at the base of the trim, the base being pressed against the lower face by a strap having holes in which the guiding mechanism is engaged. The strap and/or the guiding mechanism are disposed in a housing beneath the lower face of the surrounding covering.

The present invention relates to an arrangement for securing the base of a gaiter of a gearshift lever to the periphery of a surrounding interior trim which comprises guide means on an underside of said interior trim which are capable of positioning the base of the gaiter by engagement of these guide means in corresponding holes formed at the base of the gaiter, said base being pressed firmly against this underside by a band that has holes through which the guide means engage.

The gearshift lever which can be actuated by the driver of a motor vehicle is mounted such that it is articulated, projecting from a control casing. This casing is generally mounted on the floor of the cabin of the vehicle, in a housing formed in a surrounding part of the covering interior trim.

A trim or “gaiter” then covers the housing, so as to hide the control casing and prevent small particles and/or dust from getting in. This gaiter also has a function of reducing cabin noise because it is able to limit the upward transmission of engine compartment noise via the gear linkage.

In general, this flexible gaiter is of frustoconical shape and is fixed, at its top, to the gearshift lever and, at its base, to the upper periphery of the housing formed in the surrounding part of the interior trim, the gaiter thus allowing the lever to pivot freely in all directions so that the driver can change gear. Exemplary embodiments are, for example, described in documents JP61046721.

However, aside from the disadvantage of having grooves that may collect dust and other particles and present a health problem, a subassembly such as this calls for protruding securing means. The presence of these securing means on the upper portion of the surrounding part of the interior trim gives rise to problems of comfort and of ergonomics. In addition, because of the pull-out stresses to which the gaiter is exposed during driver action on the lever, the firmness with which the gaiter is pressed against the surrounding part of the interior trim diminishes over time, giving rise to problems of sealing.

There are systems that solve these problems in part, but at the expense of greater complexity and higher cost. This is particularly the case of the subassembly proposed in document JP2003104081 in which the base of the gaiter is first of all secured in a groove formed on the upper periphery of the housing, by protruding securing means. This groove is then covered with a band the shape of which complements that of the groove so as to cover and hide the securing means.

It is an object of the present invention to make improvements to such subassemblies to ensure better comfort and improved ergonomics for the occupants of the motor vehicle by attaching a flexible gaiter using securing means that do not protrude, in order in particular to protect the control casing from any particles which could hamper its operation.

More especially proposed is a subassembly of the aforementioned type, in which the band and/or the guide means are positioned in the housing under the underside of the surrounding interior trim.

According to other advantageous features of the invention, which may be considered separately or in combination:
one end of at least one part of the guide means has a deformation which increases the cross section of said means to a dimension substantially greater than that of the holes formed in the band so as to give these guide means a securing function;
the band comprises an upstand near an edge of the surrounding interior trim delimiting the opening formed therein;
surface treatments and/or surface finishes are performed and/or created on at least one of the following: the underside of the surrounding interior trim; an upper face of the band; and the base of the gaiter;
the deformation of the end of the guide means is obtained by deforming in the hot state and/or with the aid of ultrasound;
the guide means are positioned at the periphery of the housing in such as way as to constitute polarizing means;
the guide means at the periphery of the housing and the corresponding holes in the base of the gaiter are positioned in such a way as to obtain a substantially constant tension in the gaiter.

The invention also relates to a method of assembling an arrangement according to the invention and comprising, in succession:
a) a first step during which the base of the gaiter is positioned against the underside of the surrounding interior trim by engaging the guide means in the corresponding holes already formed in the base of the gaiter;
b) in a second step, the band is positioned under the base of the gaiter positioned under the underside of the surrounding interior trim by engaging the guide means through the corresponding holes already formed in the band, and applying a retaining pressure;
c) and in a third step, the lower end of the guide means is deformed in such a way as to increase its cross section to a value greater than the size of the holes formed in the band and the retaining pressure is released when the deformation of the stakes is permanent.

The invention will now be described through an example with reference to the following attached drawing:

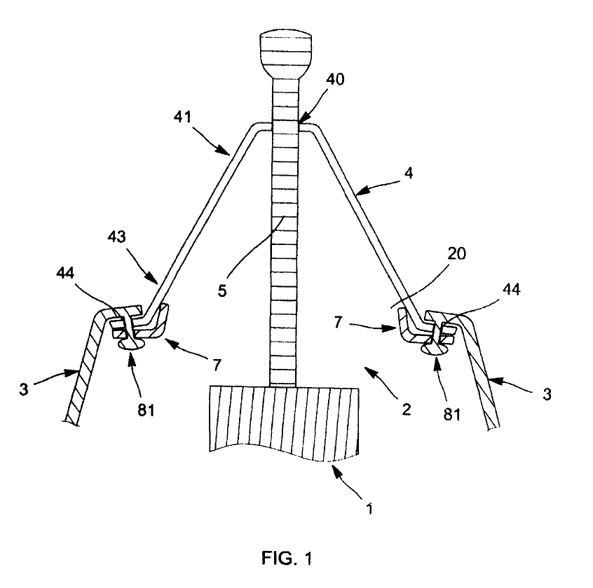

FIG. 1 is a section on a vertical plane passing through the axis of the gearshift lever, of a control casing housed in a housing formed in a surrounding interior trim element, sealed by a gaiter according to the invention;

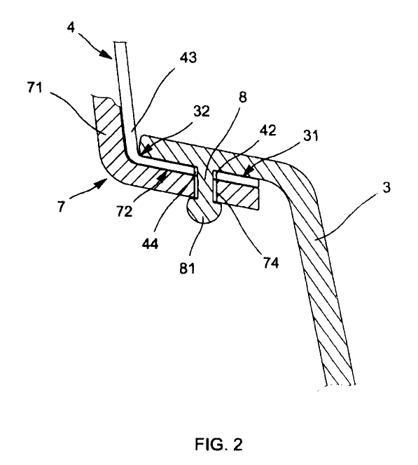

FIG. 2 is a section of the subassembly used to secure a gaiter to the periphery of a housing formed in a surrounding interior trim element.

The description which will follow will adopt, as its reference, the axis [L-L] formed by the gearshift lever and which runs substantially vertically between a bottom or lower part, mounted on a control casing, and a top or upper part, at the knob end of the gearshift lever via which the driver operates this lever.

As depicted in FIG. 1, a gearbox control casing 1 is arranged in a housing 2 created in a surrounding interior trim 3. The surrounding interior trim 3 may then be attached to a rigid part of the cabin or to part of the motor vehicle cabin console.

A gearshift lever 5 is mounted such that it can pivot on this casing 1, and projects through an opening 20 formed in the interior trim 3, so that it can be actuated by the driver of the motor vehicle with a view to changing gear.

A gaiter 4 closes off the opening 20 created in the interior trim 3 the housing 2 and extends between the surrounding interior trim 3 and the upper part of the gearshift lever 5 in such a way as to at least partially envelop this lever. Furthermore, the gaiter 4 allows the casing to be perfectly isolated from the outside in respect of particles and/or dust.

At the upper part 41, the gaiter 4 is pierced with an upper opening 40 to allow the lever 5 through. To secure the gaiter 4 to the upper part of the gearshift lever 5 use is made of the conventional upper securing means (not depicted), such as securing clamps, elastic bands and/or clipping devices.

According to the embodiment depicted in the figures, the gaiter 4 has, at its lower part 43, an opening of a diameter slightly greater than the diameter of the housing 2.

More generally, in the remainder of the description, the lower part 43 of the gaiter 4 which is secured to the surrounding interior trim 3 will be termed the “base”.

The lower securing means 8 which pass through the gaiter 4 are positioned on an underside 31 of the surrounding interior trim 3 which delineates the opening 20.

According to the invention, the gaiter 4 is pressed firmly against the underside 31 of the surrounding interior trim 3 by a band 7, the gaiter 4 thus being firmly gripped and sandwiched between this band 7 and the underside of the interior trim 3.

This arrangement of the securing means is particularly advantageous because the securing means have projections that extend downward into the housing 2 which means that they are not accessible to the occupant when the gaiter 4 is in place in the vehicle.

In addition, unlike securing means positioned on the upper part of the interior trim 3, for which the pull-out forces on the gaiter 4 as the gearshift lever is moved are located around said securing means, according to the invention, by virtue of these lower securing means, the forces are distributed over the area of overlap between the band 7 and the surrounding interior trim 3.

FIG. 2 details the arrangement that allows the base of the gaiter 4 to be secured to the surrounding interior trim 3 and, more specifically, details the make-up of the lower securing means according to the invention, as an enlargement of a portion of the section that is FIG. 1.

Guide means, such as stakes 8, are formed on, and preferably molded into, the underside 31 of the surrounding interior trim 3, at the periphery of the opening 20 so that the gaiter 4 can be slipped onto them, engaging the stakes 8 in corresponding holes 44.

The band 7 is also provided with holes 74 arranged in register with the stakes 8, and is pressed against the gaiter 4 slipped over the surrounding interior trim 3, in order to press and retain it firmly in position.

According to the invention, at least some of the stakes 8 are deformed once they have been engaged through the gaiter 4 and the band 7, so as to increase their cross section at their end. The stakes 8 thus deformed then constitute means of securing the band 7 and the gaiter 4 against the surrounding interior trim 3.

Stakes 8 may be deformed thermally or by ultrasonic welding, notably using a sonotrode.

At the time of deformation, and in order to improve the integrity, the stake may be welded to the band also.

The number and position of the stakes 8 which have the dual function of guiding and of securing are a compromise between the complexity and duration of the assembly of the securing arrangement and the durability of the seal over time.

As a preference, the stakes 8 are made in a material that can be deformed in the hot state.

To increase the dimensions of the cross section of the stakes 8 it is possible in particular to use a rivet-heading method.

According to the alternative form of embodiment depicted in FIG. 2, the band 7 has an upstand 71 near an edge 32 delineating the opening 20 formed in the surrounding interior trim 3 in order to improve the rigidity of the arrangement at this edge 32, and more particularly in order to prevent the gaiter 4 from collapsing. This upstand also makes it possible to prevent dust and other particles from slipping in between the gaiter 4 and the surrounding interior trim 3, at this edge 32. This also guards against the base 43 of the gaiter 4 becoming worn through friction on any abrasive particles that might be present.

The layout of these stakes 8 is adapted to optimize the distribution of pull-out forces on the gaiter 4 at its base, according to the shape of the periphery of the housing 2.

By arranging the stakes 8 non-uniformly around the periphery of the housing 2, these stakes 8 may constitute polarizing means, in the event that the opening is not fully symmetric.

In addition, the layout of the guide means 8 at the periphery of the housing 2 and of the corresponding holes in the base of the gaiter 4 is adapted in such a way as to obtain substantially constant tension in the gaiter 4.

According to an alternative form of embodiment, surface treatments are performed on at least one of the following: the underside 31 of the surrounding interior trim 3; the upper face of the band 7; and the base of the gaiter 4. These surface treatments are aimed at improving the adhesion between these various elements and at limiting the pulling-out of the gaiter 4.

A surface finish may also be created on at least one of the following: the underside 31 of the surrounding interior trim 3; the upper face of the band 7; and the base of the gaiter 4, examples being striations or other roughnesses.

In this configuration, a method of assembling an arrangement 10 of the kind described hereinabove comprises a first step during which the base of the gaiter 4 is positioned against the underside 31 of the surrounding interior trim 3 while engaging the guide means 8 in the corresponding holes 44 already formed in the base of the gaiter 4.

Next, during a second step, the band 7 is placed under the base of the gaiter 4 positioned under the underside 31 of the surrounding interior trim 3 while engaging the guide means 8 through the corresponding holes 74 already formed in the band 7, applying a retaining pressure.

Then, during a third step, the lower end 81 of the guide means 8 is deformed in such a way as to increase their cross section to a value greater than the dimension of the holes 74 formed in the band 7. The retaining pressure is then released when the deformation of the stakes is permanent, for example once they have cooled.

As a preference, the deformation is performed in such a way that the band 7 is fixed in the position in which the elements of the arrangement, positioned in the first two steps, are maintained, so as to prevent any play between the surrounding interior trim 3, the base of the gaiter 4 and the band 7.

This third step may advantageously be performed using deformation in the hot state, for example using a rivet-heading method.

The invention therefore enables the securing of the base of the gaiter 4 that seals the housing 2 in which the casing 1 used to control the gearshift lever 5 is arranged while at the same time hiding the securing means that hold it against the surrounding interior trim 3.

1-8. (canceled)

9. An arrangement for securing a base of a gaiter of a gearshift lever to a periphery of a surrounding interior trim, comprising:
guide means on an underside of the interior trim for positioning the base of the gaiter by engagement of the guide means in corresponding first holes formed at the base of the gaiter, the base being pressed firmly against the underside by a band including second holes through which the guide means engage,
wherein the band and/or the guide means are positioned in the housing under the underside of the surrounding interior trim.

10. The arrangement as claimed in claim 9, wherein one end of at least one part of the guide means includes a deformation that increases cross section of the guide means to a dimension substantially greater than that of the second holes formed in the band to give the guide means a securing function.

11. The arrangement as claimed in claim 9, wherein the band comprises an upstand near an edge of the surrounding interior trim delimiting an opening formed therein.

12. The arrangement as claimed in claim 9, wherein surface treatments and/or surface finishes are performed and/or created on at least one of the following: the underside of the surrounding interior trim; an upper face of the band; the base of the gaiter.

13. The arrangement as claimed in claim 10, wherein the deformation of the end of the guide means is obtained by deforming in a hot state and/or with aid of ultrasound.

14. The arrangement as claimed in claim 9, wherein the guide means is positioned at a periphery of the housing to constitute polarizing means.

15. The arrangement as claimed in claim 9, wherein the guide means at a periphery of the housing and the corresponding first holes in the base of the gaiter are positioned to obtain a substantially constant tension in the gaiter.

16. A method of assembling an arrangement as claimed in claim 9, comprising, in succession:
a) positioning the base of the gaiter against the underside of the surrounding interior trim by engaging the guide means in the corresponding first holes already formed in the base of the gaiter;
b) positioning the band under the base of the gaiter positioned under the underside of the surrounding interior trim by engaging the guide means through the corresponding second holes already formed in the band, and applying a retaining pressure;
c) deforming the lower end of the guide means to increase its cross section to a value greater than the size of the second holes formed in the band and releasing the retaining pressure when the deformation of the stakes is permanent.
